(19) United States
(12) Patent Application Publication
(10) Pub. No.: US 2011/0317034 A1
(43) Pub. Date: Dec. 29, 2011

(54) IMAGE SIGNAL PROCESSOR MULTIPLEXING

(76) Inventors: MADHU S. ATHREYA, Saratoga, CA (US); JIANPING ZHOU, Fremont, CA (US)

(21) Appl. No.: 12/824,292

(22) Filed: Jun. 28, 2010

(51) Int. Cl. H04N 5/76

(52) U.S. Cl. 348/231.99; 348/E05.024

(57) ABSTRACT

In some embodiments, an electronic device comprises a first camera and a second camera, a first buffer to receive a first set of input frames from the first camera and a second buffer to receive a second set of input frames from the second camera, a single image signal processor coupled to the first buffer and the second buffer to process the first set of input frames from the first frame buffer using one or more processing parameters stored in a first memory to generate a first video stream and to process the second set of input frames from the second frame buffer using one or more processing parameters stored in a second memory register to generate a second video stream, and a memory module to store the first video stream and the second video stream.

### BACKGROUND

The subject matter described herein relates generally to the field of image processing and more particularly to systems and methods for image signal processor multiplexing.

Electronic devices such as mobile phones, personal digital assistants, portable computers and the like may comprise a camera to capture image images. By way of example, a mobile phone may comprise a camera disposed on the back of the phone to capture images. Electronic devices may be equipped with an image signal processing pipeline to capture images collected by the camera, process the images and store the images in memory and/or display the images.

Techniques to equip electronic devices with multiple cameras may find utility.

### BRIEF DESCRIPTION OF THE DRAWINGS

The detailed description is described with reference to the accompanying figures.

FIG. 1 is a schematic illustration of an electronic device for use in image signal processor multiplexing, according to some embodiments.

FIG. 2 is a schematic illustration of components for use in image signal processor multiplexing, according to embodiments.

FIG. 3 is a schematic illustration of data flows in image signal processor multiplexing, according to some embodiments.

FIG. 4 is a flowchart illustrating in image signal processor multiplexing according to some embodiments.

### DETAILED DESCRIPTION

Described herein are exemplary systems and methods for image signal processor multiplexing. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In some embodiments, the subject matter described herein enables an electronic device to be equipped with multiple cameras without the need for independent image signal processor channels. Thus, the systems and method described herein enable an electronic device to multiplex image signals from multiple cameras through a single image processor pipeline. The image signals may be stored in memory and/or displayed on a display device.

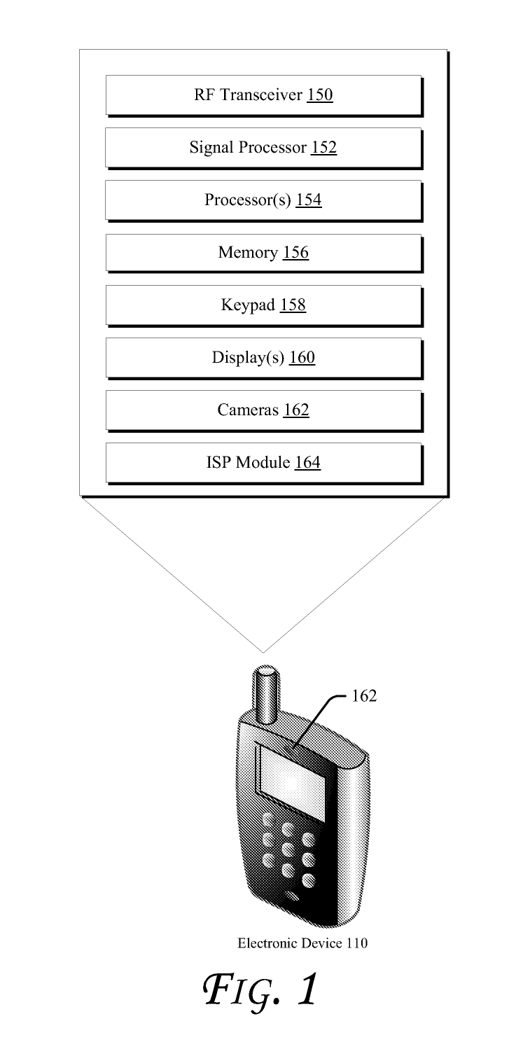

FIG. 1 is a schematic illustration of an electronic device for use in image signal processor multiplexing, according to some embodiments. Referring to FIG. 1, in some embodiments electronic device 110 may be embodied as a mobile telephone, a personal digital assistant (PDA) or the like. Electronic device 110 may include an RF transceiver 150 to transceive RF signals and a signal processing module 152 to process signals received by RF transceiver 150.

RF transceiver may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 110 may further include one or more processors 154 and a memory module 156. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 154 may be one or more processors in the family of Intel® PXA27x processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design. In some embodiments, memory module 156 includes random access memory (RAM); however, memory module 156 may be implemented using other memory types such as dynamic RAM (DRAM), synchronous DRAM (SDRAM), and the like. Electronic device 110 may further include one or more input/output interfaces such as, e.g., a keypad 158 and one or more displays 160.

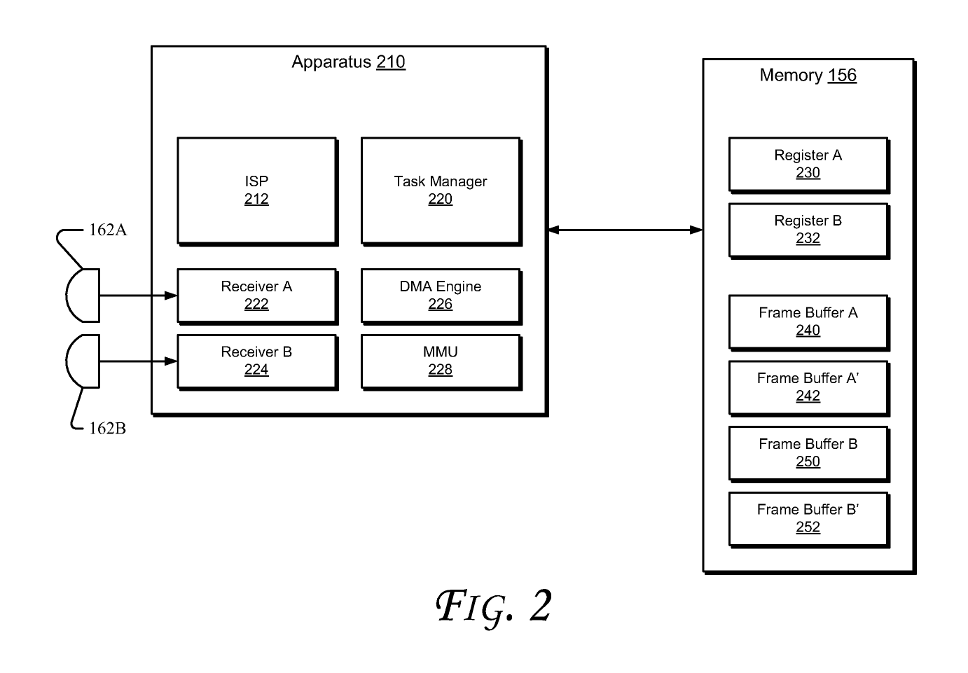

In some embodiments electronic device 110 comprises two or more cameras 162 and an image signal processor 164. By way of example and not limitation, a first camera 162 may be positioned on the front of electronic device 110 and a second camera may be positioned on the back of electronic device 110. Aspects of the cameras and image signal processor 164 and the associated pipeline will be explained in greater detail with reference to FIGS. 2-4.

FIG. 2 is a schematic illustration of components for use in image signal processor multiplexing, according to embodiments. Referring to FIG. 2, in some embodiments an ISP module 164 may be implemented as an integrated circuit, or a component thereof, or as a chipset, or as a module within a System On a Chip (SOC). In alternate embodiments the ISP module 164 may be implemented as logic encoded in a programmable device, e.g., a field programmable gate array (FPGA) or as logic instructions on a general purpose processor, or logic instructions on special processors such a Digital Signal Processor (DSP) or Single Instruction Multiple Data (SIMD) Vector Processors

In the embodiment depicted in FIG. 2, the ISP module 164 comprises an image signal processor 212, a task manager, 220, a first camera receiver 222 and a second camera receiver 224, a direct memory access (DMA) engine 226 and a memory management unit (MMU) 228. ISP module 164 is coupled to a memory module 156. Memory module 156 maintains a first register 230 and a second register 232, a frame buffer A 240 and frame buffer A′ 242, a frame buffer B 250 and frame buffer B′ 252. The two threads of 3A (Auto-white balance, Auto-focus, Auto-exposure) 400A and 400B for each camera, run on a host CPU, which may correspond to the processor(s) 154 depicted in FIG. 1.

Operations of the electronic device will be explained with reference to FIGS. 2-4. In some embodiment images from a first camera 162A are input into a first receiver 222 (operation 410) and images from a second camera 162B are input into a second receiver 224 (operation 415). In some embodiments cameras 162A and 162B, sometimes referred to collectively herein by the reference numeral 162, may comprise an optics arrangement, e.g., one or more lenses, coupled to an image capture device, e.g., a charge coupled device (CCD). The output of the charge coupled device may be in the format of a Bayer frame. The Bayer frames output from the CCD or CMOS device may be sampled in time to produce a series of Bayer frames, which are directed into receivers 222, 224. These unprocessed image frames may sometimes be referred to herein as raw frames. One skilled in the art will recognize that the raw image frames may be embodied as an array or matrix of data values. In some embodiments the control program to adjust the focus, white balance and exposure is implemented in the process threads 3A, 400A and 400B.

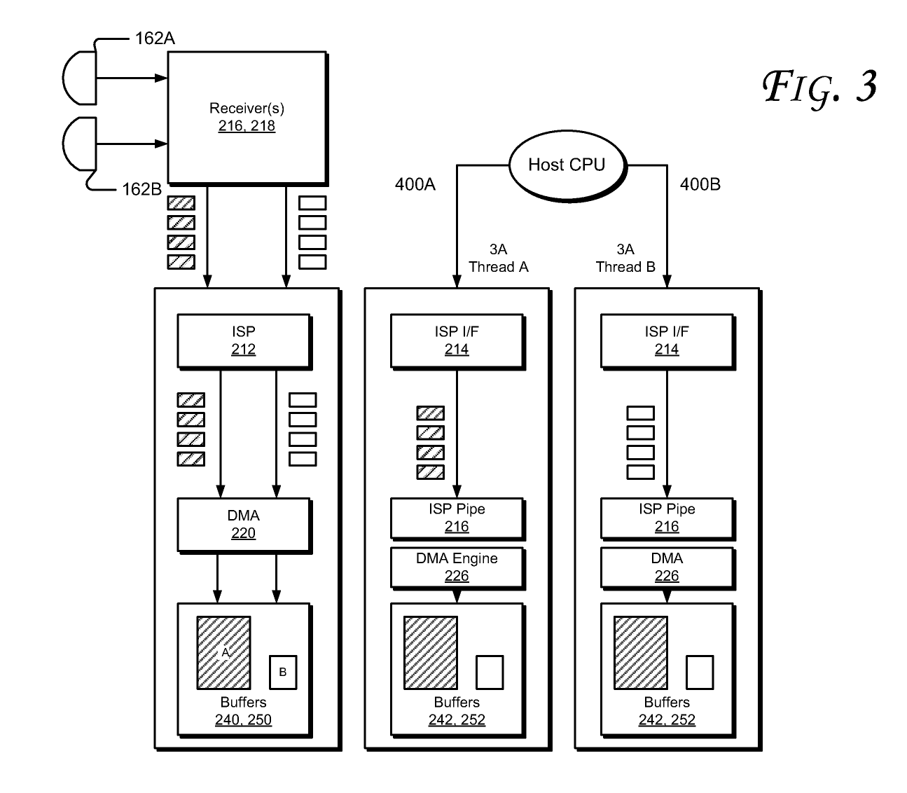

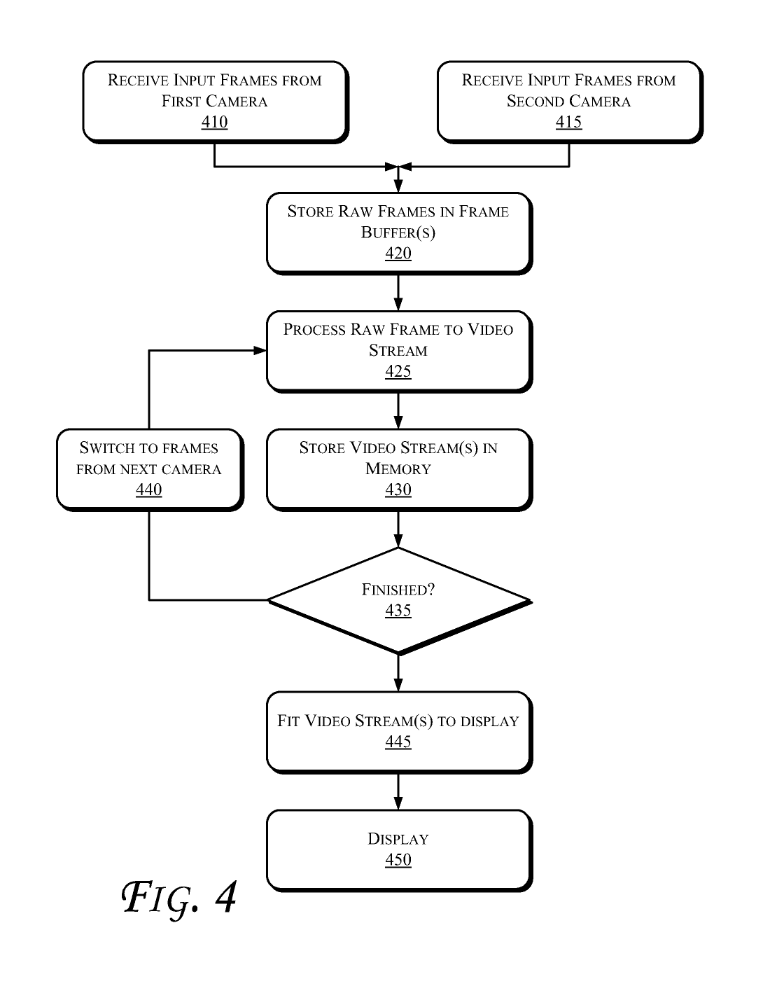

At operation 420 (FIG. 4) the raw frames are stored in frame buffers. Referring to FIGS. 2 and 3, images from the cameras 162 are input into the receivers 222, 224. In some embodiments the direct memory access engine 220 retrieves the image frame from receiver A 216 and stores the image frame in frame buffer A 240. Similarly, the DMA engine 220 retrieves the image frame from receiver B 218 and stores the image frame in frame buffer B 250.

Operations 425-440 define a loop by which the raw frames in the frame buffers 240, 250 are processed to a video stream format. In some embodiments frame process is done one frame at a time from each camera source such that frame processing is interleaved. Thus, at operation 425 the contents of frame buffer A are input to the image signal processor 212 through an image signal processor interface 214, which feeds the contents of frame buffer A into an image signal processor pipeline 216. As illustrated in FIG. 3, the contents of frame buffer A are processed in the pipeline 216, for example by converting the content of the frame buffer 240 from raw Bayer frames into a suitable video format, e.g., a corresponding number of YUV video frames. The image signal=processor 212 may pass parameters from frame buffer A with thread 3A 400A. The processing thread 3A 400A may use these parameters to set suitable settings on cameras 162. 3A parameters and parameters for processing the frames in frame buffer A may be passed by first storing in register A. At operation 430 a direct memory access (DMA) engine 226 stores the YUV video frames in a memory buffer 242 in memory 156.

If, at operation 435, the frame processing is not finished then control passes back to operation 425 and more raw frames in the frame buffers are processed in an interleaved fashion to a video stream format. By way of example, in embodiments in which two or more cameras are utilized the contents of frame buffer B are input to the image signal processor through an image signal processor interface 214, which feeds the contents of frame buffer B into an image signal processor pipeline 216. The contents of frame buffer B are processed in the pipeline, for example by converting the content of the frame buffer from raw Bayer frames into a suitable video format, e.g., a corresponding number of YUV video frames. The 3A 400 Frame B is processed based on parameters passed through Register B. At operation 430 the video stream generated from the raw video frames in the buffer are stored in memory. In some embodiments the DMA engine 226 stores the video stream generated from frame buffer B 240 in a second frame buffer B′ 252 in memory 156. In some embodiments the video streams may be stored in a picture-within-a-picture view. In some embodiments the video streams may be encoded and retained as two streams through multi-video coder/decoders (codecs), such that the video streams can be displayed on any target device.

Again, if at operation 435 the frame processing is not finished, then control passes to operation 440 and processing is switched from receiver B back to receiver A. Thus, operations 425-435 define a loop by which raw frames from multiple cameras may be multiplexed into video streams and stored in the memory of an electronic device.

By contrast, if at operation 435 the frame buffers are finished processing, then control passes to operation 445, and the video streams are fit to a display. In some embodiments the video streams are combined into a picture-within-picture view. At operation 450 the video streams may be presented on a display.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method, comprising:
receiving a first set of input frames from a first camera into a first buffer and a second set of input frames from a second camera into a second buffer;
processing the first set of input frames from the first frame buffer using one or more processing parameters to generate a first video stream;
processing the second set of input frames from the second frame buffer using one or more processing parameters to generate a second video stream; and
storing the first video stream and the second video stream in a memory module.

2. The method of claim 1, wherein receiving a first set of input frames from a first camera into a first buffer comprises receiving a first set of input frames from a first camera into a first camera receiver; and further comprising:
performing a direct memory access read of the first set of input frames from the first camera receiver to the first buffer.

3. The method of claim 2, wherein receiving a second set of input frames from a second camera into a second buffer comprises receiving a second set of input frames from a second camera into a second camera receiver; and further comprising:
performing a direct memory access read of the second set of input frames from the second camera receiver to the second buffer.

4. The method of claim 1, wherein processing the first set of input frames from the first frame buffer using one or more processing parameters stored in a first memory to generate a first video stream comprises converting one or more raw frames into one or more YUV video frames.

5. The method of claim 4, wherein processing the second set of input frames from the second frame buffer using one or more processing parameters stored in a second memory to generate a second video stream comprises converting one or more raw frames into a corresponding number of YUV video frames.

6. The method of claim 1, wherein:
storing the first video stream and the second video stream in a memory module comprises generating a composite image from the first video stream and the second video stream, and further comprising presenting the composite image on a display device for the electronic device.

7. An electronic device, comprising:
a first camera and a second camera;
a first buffer to receive a first set of input frames from the first camera and a second buffer to receive a second set of input frames from the second camera;
a single image signal processor coupled to the first buffer and the second buffer to process the first set of input frames from the first frame buffer using one or more processing parameters stored in a first memory to generate a first video stream and to process the second set of input frames from the second frame buffer using one or more processing parameters stored in a second memory register to generate a second video stream; and
a memory module to store the first video stream and the second video stream.

8. The electronic device of claim 7, further comprising:
a first camera receiver to receive a first set of input frames from a first camera;
a direct memory engine to perform a direct memory access read of the first set of input frames from the receiver to the frame buffer.

9. The electronic device of claim 8, further comprising:
a second camera receiver to receive a second set of input frames from a second camera;
a direct memory engine to perform a direct memory access read of the second set of input frames from the receiver to the frame buffer.

10. The electronic device of claim 7, wherein the image processor is to convert one or more raw frames from the first set of input frames into a corresponding number of YUV video frames.

11. The electronic device of claim 10 wherein the image processor is to convert one or more raw frames from the second set of input frames into one or more YUV video frames.

12. The electronic device of claim 7, wherein the memory is to store a composite image generated from the first video stream and the second video stream.

13. The electronic device of claim 12, further comprising a display to present the composite image.

14. An apparatus, comprising:
a single image signal processor comprising logic to:
process a first set of input frames from a first receiver using one or more processing parameters stored in a first memory register to generate a first video stream; and
process the second set of input frames from the second frame buffer using one or more processing parameters stored in a second memory register to generate a second video stream.

15. The apparatus of claim 14, further comprising:
a first camera receiver to receive a first set of input frames from a first camera;
a direct memory engine to perform a direct memory access read of the first set of input frames from the receiver to the frame buffer.

16. The apparatus of claim 15, further comprising:
a second camera receiver to receive a second set of input frames from a second camera;
a direct memory engine to perform a direct memory access read of the second set of input frames from the receiver to the frame buffer.

17. The apparatus of claim 15, wherein the image processor is to convert one or more raw frames from the first set of input frames into a corresponding number of YUV video frames.

18. The apparatus of claim 16, wherein the image processor is to convert one or more raw frames from the second set of input frames into a corresponding number of YUV video frames.

19. The apparatus of claim 14, further comprising a memory module to store a composite image generated from the first video stream and the second video stream.

20. The apparatus of claim 19, further comprising a display to present the composite image.
